(19) United States
(12) Patent Application Publication
(10) Pub. No.: US 2025/0385631 A1
(43) Pub. Date: Dec. 18, 2025

(54) ADJUSTMENT SYSTEM AND OPERATING METHOD WITH ADAPTATION ROUTINE

(71) Applicant: Brose Fahrzeugteile SE & Co. KG, Bamberg, Bamberg (DE)

(72) Inventors: Maximilian Kunzelmann, Bamberg (DE); Daniel Schnapp, Ebensfeld (DE); Daniel Steiner, Frankenblick (DE); Matthias Geier, Bamberg (DE)

(21) Appl. No.: 18/879,129

(22) PCT Filed: Jun. 23, 2023
(86) PCT No.: PCT/EP2023/067207

§ 371 Date: Dec. 26, 2024

(30) Foreign Application Priority Data
Jun. 27, 2022 (DE) 10 2022 115 974.4

(51) Int. Cl. H02P 23/14; E05F 15/622

(52) U.S. Cl. CPC H02P 23/14; E05F 15/622; E05Y 2400/3015; E05Y 2400/31; E05Y 2400/456; E05Y 2900/531

(57) ABSTRACT

It is provided an adjustment system for a vehicle, comprising an adjustment element adjustable along two mutually opposite adjustment directions, an adjustment drive with at least one electric drive motor for generating a drive force for adjusting the adjustment element, and an electronic control unit for controlling the drive motor by specifying a motor current for generating the drive force in a height required for an adjustment operation, wherein via the electronic control unit at least one control variable is specified for setting the motor current. The control variable is based on a torque constant for the electric drive motor and an efficiency parameter characterizing the efficiency of the adjustment drive, which in the regular operation of the adjustment system can be updated via an adaptation routine.

### CROSS REFERENCE TO RELATED APPLICATIONS

The present application is a U.S. National Phase of International Application No. PCT/EP2023/067207 entitled “ADJUSTMENT SYSTEM AND OPERATING METHOD WITH ADAPTATION ROUTINE,” and filed on Jun. 23, 2023. International Application No. PCT/EP2023/067207 claims priority to German Patent Application No. 10 2022 115 974.4 filed on Jun. 27, 2022. The entire contents of each of the above-listed applications are hereby incorporated by reference for all purposes.

### BACKGROUND

The proposed solution in particular relates to an adjustment system for a vehicle comprising an adjustment element adjustable in a power-assisted, in particular power-operated way.

An adjustment system comprising an adjustment drive including an electric drive motor is widely known in particular in the automotive sector. For example, doors of a vehicle, such as side doors or tailgates, nowadays regularly are configured to be adjustable in a power-operated or at least power-assisted way. What is meant by a power-assisted adjustment of an adjustment element in particular is a servo assistance, i.e. a motorized assistance of a manually driven adjusting movement.

Part of the adjustment system in particular is an electronic control unit for controlling the drive motor and the drive force generated by the drive motor for an adjustment operation of the adjustment element. In the electronic control unit at least one control variable is stored, via which it is specified what motor current is to be supplied to the at least one drive motor. Thus, the control variable in particular specifies the adjustment speed and/or the height of a drive force transmitted to the adjustment element. In particular, the control variable for example is decisive for the motor current which is provided in a particular section of an adjustment range of the adjustment element, in order to adjust the adjustment element for example more slowly, more quickly or by overcoming a particular mechanical resistance. The control variable for example can also be relevant for the extent to which an obstacle is detected in an adjustment path of the adjustment element and possibly a clamping case is detectable, which should lead to a stopping or reversing of the adjusting movement of the adjustment element.

For specifying the control variable different approaches are known from the prior art. Typically, it is provided that the control variable takes account of particular characteristic variables of the drive motor and of a mechanism of the adjustment system. Corresponding characteristic variables for example include a torque constant of the drive motor (as a measure for a (driving) torque to be generated with a particular motor current), an idle current of the drive motor and/or an efficiency. The characteristic variables of the adjustment system, however, are different from drive to drive according to experience, and in particular are highly variably throughout the service life of the adjustment system.

To comply with the individual character of corresponding characteristic variables depending on the adjustment system, it already is widely known to provide a calibration. Corresponding calibrations then for example are performed at the end of a manufacturing process of the adjustment system and/or of the adjustment drive, for example before a delivery of the adjustment drive to a vehicle or after properly mounting the adjustment system to the vehicle.

While during possible calibration operations “ex works” additional measurement quantities can be used in order to calibrate the adjustment system, such additional measurement quantities no longer are available after putting the adjustment system into operation and in use of the vehicle. This applies for example to a measurement of a drive force applied on the adjustment element by means of the at least one drive motor. One or more force sensors required therefor are not integrated on the adjustment system and neither can be integrated easily. For example, in an adjustment system for a side door or a liftgate of a vehicle it can very well be checked before a delivery what the height of a drive force transmitted to the side door or the liftgate is in dependence on a motor current provided to the at least one drive motor. In the properly mounted state of the adjustment system such a force measurement then typically is not possible any longer, as the same typically cannot be realized without any additional measuring sensors and measuring apparatuses.

Throughout the service life of the adjustment system, however, characteristic variables of the drive motor and/or of the adjustment mechanism relevant for the control of an adjusting movement can change significantly. Without any suitable measures, this can involve undesired impairments of the adjusting movement of the adjustment element, for example because a friction in the system has significantly increased in such a way that an applied drive force no longer is sufficient to achieve a particular adjustment position or the electronic control unit proceeds from an obstacle in the adjustment path of the adjustment element.

### SUMMARY

Against this background it is the object underlying the proposed solution to provide an adjustment system improved in this respect.

This object is achieved with an adjustment system as described herein and with an operating method as described herein.

According to a first aspect of the proposed solution there is provided an adjustment system for a vehicle, in which via an electronic control unit of the adjustment system at least one control variable is specified for setting a motor current for at least one electric drive motor, and this control variable is based on a torque constant for the electric drive motor and an efficiency parameter characterizing the efficiency of the adjustment drive. Furthermore, the electronic control unit is configured to carry out an adaptation routine for updating the efficiency parameter in operation of the adjustment system.

Consequently, it is a fundamental idea of the proposed solution to make the control variable for setting the motor current dependent on a torque constant on the one hand and on an efficiency parameter on the other hand, wherein especially the efficiency parameter is considered and hence can be updated separately from the torque constant. In connection with an adaptation routine to be performed at the running time of the adjustment system the proposed adjustment system is able to selectively update the efficiency parameter that possibly has changed significantly over the running time of the adjustment system and separately therefrom leave the torque constant unchanged or independently update a value for the torque constant. The (repeated) execution of an adaptation routine for updating a characteristic variable in the form of the efficiency parameter or a value therefor in operation of the adjustment system and hence after putting the same into operation on a vehicle is to be distinguished from a calibration routine, which for example is performed after a completion of the adjustment system for the one-time learning of particular characteristic variables. An adaptation routine in the sense of the proposed solution can be performed repeatedly throughout a service life of the adjustment system, in particular without this requiring the utilization of an additional measuring apparatus at the vehicle.

After carrying out an adaptation routine, an updated value for the efficiency parameter can be utilized for a power-assisted adjustment of the adjustment element. In accordance with the proposed solution it is not absolutely necessary that during the execution of the adaptation routine a value for the efficiency parameter is updated and stored directly. It can rather be sufficient that during the adaptation routine at least one value for an auxiliary parameter is updated and stored, with which the efficiency parameter can be calculated. An efficiency parameter for the control variable thus can be calculated in operation of the adjustment system on the basis of a stored and updateable auxiliary parameter. What is independent of this is the possibility that in operation of the adjustment system outside the adaptation routine a value for the efficiency parameter can be adaptable in addition depending on the current operating situation, for example with regard to motor and/or transmission temperatures of the adjustment drive, and hence in the end also a value for the control variable.

In principle, the proposed solution in particular is suitable for an adjustment system for providing a servo assistance for an adjustment element to be adjusted. Here, for example, the height of a drive force of the electric drive motor generated via the specification of the motor current depends on an adjusting force manually acting on the adjustment element. The control variable specifies the motor current to be specified in dependence on the required height of the drive force. For example, in the case of a servo assistance at a vehicle the objective in particular is that a user can comfortably adjust an adjustment element with a manually applied adjusting force limited to a maximum, without the adjusting force to be applied by the user noticeably varying over an adjustment range of the adjustment element and/or an adjustment direction of the adjustment element. For example, a side door or liftgate always should be adjustable for a user almost equally smoothly, regardless of whether the respective side door or liftgate is closed or opened and regardless of whether the side door or liftgate is to be adjusted for example due to the vehicle being parked on a slope in an adjustment direction against a higher weight force. Correspondingly, in the case of a servo assistance a motor current adapted to the respective operating situation should be variably specifiable via the electronic control unit. To then ensure this as exactly and reliably as possible, a knowledge of particular characteristic variables of the adjustment system in the electronic control unit is absolutely necessary. In this connection, the proposed solution then provides for a particular, efficient updating of corresponding characteristic variables.

In one embodiment, it is provided to calculate a value for a coefficient of friction when carrying out the adaptation routine. A corresponding coefficient of friction here can serve for updating the efficiency parameter and storing the same. Alternatively, the value for the coefficient of friction calculated in connection with the adaptation routine can be stored as an updated value for an auxiliary parameter. The efficiency parameter for an adjustment of the adjustment element subsequently can be calculated from the auxiliary parameter, which together with a value for the torque constant is included into the control variable via which the height of the motor current for the electric drive motor is specified.

In an adaptation routine for updating the control variable it is provided, for example, to adjust a drive element of the adjustment drive via the drive motor, which is coupled with the adjustment element for transmitting the drive force to the adjustment element. For example, the drive element is a rotatable drive or rotor shaft of the adjustment drive. In connection with the adaptation method, it can now be provided to initially adjust a drive element via the drive motor in a first phase against a restoring force in a first drive direction, and subsequently in a second phase permit a (backward) adjustment of the drive element in an opposite second drive direction by lowering the motor current by action of the restoring force. From at least two values for the motor current detected during the first phase and at least two values for the motor current detected during the second phase at least two difference values of the motor current can be formed and be utilized for updating the control variable. What is a starting point for a corresponding adaptation routine for updating the control variable here is the consideration that via a corresponding actuation of the drive motor and a related adjusting movement of the drive element coupled with the adjustment element and difference values of the motor current obtained thereby a statement can be made as to current characteristic variables of the adjustment system, for example as to a current friction within the system and hence a (total) efficiency for the conversion of a drive force generated by the at least one electric drive motor into a force applied on the adjustment element for adjusting the adjustment element.

What is meant by a restoring force acting on the adjustment element and hence the drive element coupled therewith in particular is a force inherent to the adjustment system and in particular resulting from the force currently acting on components, in particular on the adjustment element and/or on the adjustment mechanism of the adjustment system, including a force of gravity, spring force and/or clamping force. For example, at least part of a corresponding restoring force can result from a locking for the adjustment element, with which the adjustment element is held in one of two end positions of an adjustment range. The lowering of the motor current in a second phase of the adaptation routine typically is effected to below a threshold value from which the restoring force is greater than the motor-generated drive force. Consequently, the motor current is lowered to below a corresponding threshold value to such an extent that a return movement of the drive element occurs.

By adjusting the drive element in the first drive direction, the drive element for example is tensioned against this locking by using a clearance possibly inherent to the drive. When the motor current then subsequently is reduced, the drive element is again adjusted back due to the tension within the system. Here, use can be made of the fact that the adjustment both in the first drive direction and in the second drive direction is effected by action of the same restoring force, so that by considering the difference values of the motor current the corresponding height of the restoring force and hence a friction within the system can be inferred, without a direct measurement of the restoring force being necessary.

In principle, more than two motor current values per phase can also be detected. This in particular includes the fact that for each phase more than two motor current values are detected and at least one of the difference values is calculated by a mean value or a gradient of detected motor current values.

The implementation of an adaptation routine, in which an actuation of the at least one drive motor in two different first and second phases is effected according to the proposed pattern, and also is independent of a specification of a control variable on the basis of a torque constant and an efficiency parameter (although this is also regarded as advantageous therefor). The execution of a corresponding adaptation routine thus also is to be regarded as advantageous independently of a first aspect of the proposed solution.

By utilizing at least two difference values for the motor current, which are detected on execution of the adaptation routine, for example a value for the efficiency parameter or a value for an auxiliary parameter, with which the efficiency parameter can be calculated, can be updated. The detected motor current values and the motor current difference values calculated therefrom thus are included in a calculation with which an efficiency parameter or a value for an auxiliary parameter are updated.

With regard to the implementation of an efficient algorithm in the electronic control unit for controlling the at least one drive motor and for updating the control variable it is provided in one embodiment to detect the values for the motor current in the second phase for identical positions of the drive element, at which the values for the motor current were detected in the first phase. A position of the drive element here can be effected by utilizing at least one position sensor, for example a Hall sensor. During the adjustment of the drive element in the first drive direction, motor current values thus for example are detected at at least two positions of the drive element determined by means of sensors. At the same positions of the drive element motor current values then are again detected when the drive element in the second phase is adjusted back along the second drive direction by action of the restoring force. The detected motor current values thus are directly related to each other, so that current characteristic variables of the adjustment drive can be determined thereby.

In one embodiment a search algorithm is implemented, by means of which for a function dependent on a coefficient of friction for the adjustment drive and comprising the two difference values for the motor current a value for the coefficient of friction can be calculated, which is associated to a zero of the function. The value for the coefficient of friction associated to the zero is utilized for specifying the updated efficiency parameter. Via the search algorithm, a value for the coefficient of friction consequently is sought for in the stored function, for which the function includes a zero. This includes the search for a value with which a function value of the function in the range of 1 (possibly plus a permitted tolerance) is obtained. A corresponding value for the coefficient of friction here can be determined directly/analytically or iteratively via a search algorithm implemented in the electronic control unit of the adjustment system.

Alternatively or additionally, an updated value for an idle current of the drive motor can be determined and stored by means of the adaptation routine. An idle current of the at least one electric drive motor is a measure for what motor current is needed, until a motor shaft of the drive motor is driven to rotate. Thus, the idle current is a measure for what motor current is needed to cover the friction losses of the at least one drive motor. Such an idle current also can change throughout the service life of the adjustment system. Correspondingly, an updated value for the idle current can be determinable in connection with a proposed adaptation method.

Such an updated value for the idle current can be calculated for example on the basis of an updated value for the efficiency parameter. For example, it can be provided in this connection that an updated value for the idle current is calculated by utilizing exactly one value for the motor current detected in the first phase of the adaptation routine and exactly one value for the motor current detected in the second phase of the adaptation routine (for the same position of a drive element) and calculated values for efficiency parameters specific for the adjustment direction. Alternatively, an updated value for the idle current can be stored in the adaptation routine by detecting a motor current when going through a mechanical clearance during an adjustment of the drive element effected by a motor.

In one embodiment, at least two different variants of the efficiency parameter are provided in the electronic control unit for the different adjustment directions of the adjustment element, so that the at least one control variable can be specified differently in dependence on the adjustment direction of the adjustment element. In the final analysis, it can very well make a control-relevant difference whether an adjustment element, such as for example a side door or liftgate, is adjusted in an opening direction or in a closing direction, as e.g. different forces here act on the respective adjustment element and/or the adjustment drive and an adjustment mechanism are loaded differently. For example, during an adjustment of the adjustment element in an opening direction a motor-generated drive force typically must have a driving effect. For an adjustment in the closing direction, on the other hand, a braking drive force counteracting the actual adjustment direction of the adjustment element possibly must be applied in order to counteract an excessive acceleration of the adjustment element in the closing direction. With the related different loads different values for the relevant characteristic variables can also be connected and change differently throughout the service life of the adjustment system. e.g. due to wear. This is taken into account in one embodiment by different variants of the efficiency parameter or by different efficiency parameters specific for the adjustment direction.

In one embodiment, for an adjustment of the adjustment element outside of the adaptation routine and hence in particular for a regular adjustment, a value for the used torque constant, which is part of the control variable, is varied in dependence on a measured temperature value. For example, a table and/or a function here can be stored in the electronic control unit in order to specify different values for the torque constant in dependence on a currently detected temperature at the adjustment drive, in particular in dependence on a temperature detected for the drive motor and/or a transmission of the adjustment drive. To merely have to store a limited number of stored values for the torque constant in a memory of the electronic control unit in dependence on a temperature, it can be provided for example that for measured temperature values, which lie between or outside of stored temperature values, a value for the torque constant to be specified is interpolated from stored values. For example, from values for the torque constant, which are stored for temperature values of T1, T2 and T3, a temperature value can be interpolated for the torque constant, which is relevant for a temperature value T4, with T4>T2>T1 and T4<T3.

Alternatively or additionally, for an adjustment of the adjustment element outside of the adaptation routine a value for an idle current of the electric drive motor can be varied in dependence on a measured temperature value. Here as well, a table and/or function can be stored in order to make different values for the idle current dependent on a temperature currently detected for the adjustment drive. Values for the idle current, which possibly are stored with respect to the temperature, here can be updateable via the execution of the adaptation routine. For example, in the delivery state of the adjustment system at least one value for the idle current is stored to obtain at least one particular temperature value or temperature range. When a new value for the idle current is determined later on in operation of the adjustment system at such a temperature or in such a temperature range (by taking account of specified tolerances), said new value is stored in the memory of the electronic control unit as an updated value.

Alternatively or additionally, for an adjustment of the adjustment element outside of the adaptation routine a value for the efficiency parameter can be determined on the basis of at least one value for an auxiliary parameter, which varies in dependence on a measured temperature value. For example, a coefficient of friction can be provided as an auxiliary parameter, which on the basis of a table or function stored in the electronic control unit is differently high depending on the temperature currently detected for the adjustment drive. Temperature-related values for the coefficient of friction can be updateable via the execution of the adaptation routine, so that for the subsequent adjustment of the adjustment element at least one updated value for the coefficient of friction is available (which then is utilized for the determination of an efficiency parameter with which motor current is specified for the drive motor).

In one embodiment, it is provided for example to utilize a temperature dependent value for a torque constant and a temperature dependent value for the efficiency parameter (the latter obtained from an updateable value for a coefficient of friction) in the electronic control unit for specifying a control variable which is the starting point for the height of the motor current provided at the electric drive motor.

The electronic control unit can be configured to carry out the adaptation routine only at particular times and here in dependence on the presence of one or more adaptation criteria. For example, the adaptation routine only is carried out when the presence of at least two of the below-mentioned adaptation criteria is detected electronically:
the adjustment element is present in a locked adjustment position at the vehicle.
the execution of a previous adaptation routine dates back longer than a predefined time period and/or number of adjustment cycles (wherein the time period and/or number can be predefined via the electronic control unit),
in the environment of the vehicle no valid authentication element (such as a key transponder) of a user of the vehicle is present, by means of which unlocking of the vehicle can be triggered,
in a vehicle interior of the vehicle no person is present,
a signal for putting the electronic control unit into a sleep mode has been generated.

Via the presence of several of the aforementioned adaptation criteria, possibly via the presence of all of the aforementioned adaptation criteria, it can be ensured that at present and also in the short-term foreseeable future (1 to 2 minutes) no adjustment of the adjustment element is to be expected and/or the (renewed) execution of an adaptation routine is expedient in order to infer possible changes of the characteristic variables of the adjustment system. When during the execution of the adaptation routine an adjustment of the adjustment element nevertheless is triggered on the part of a user, the adaptation routine is aborted.

What is part of the proposed solution furthermore is an operating method for operating an adjustment system for a vehicle, in particular for operating an embodiment of a proposed adjustment system. The advantages and features of embodiments of an adjustment system as explained above and below thus also apply for embodiments of a proposed operating method.

In connection with a proposed operating method it can thus be provided in particular that a control variable for the control of an electric drive motor of the adjustment system is based on a torque constant for the electric drive motor and an efficiency parameter characterizing the efficiency of the adjustment drive, and in operation of the adjustment system an adaptation routine is carried out for updating the efficiency parameter-possibly independently of an adaptation of the torque constant. Alternatively or additionally the adjustment drive can comprise a drive element coupled with the adjustment element for transmitting the drive force, which is adjustable in two mutually opposite driving directions. In an adaptation routine for updating the control variable
the drive element in a first phase initially can be adjusted in a first driving direction via the drive motor against a restoring force and subsequently, in a second phase, an adjustment of the drive element in the opposite second driving direction can be permitted by lowering the motor current and by action of the restoring force, and
from at least two values for the motor current detected during the first phase and at least two values for the motor current detected during the second phase two difference values are formed for updating the control variable.

In one embodiment, a value for the torque constant of the electric drive motor can be determined in a calibration routine before a first (regular) operation of the adjustment system and/or by utilizing a force measurement at the adjustment element adjusted by means of the adjustment drive. During a corresponding calibration before the delivery of the adjustment system or before the delivery at least of the adjustment drive for mounting to a vehicle, for example at least one value for the torque constant (for a particular temperature or a particular temperature range) thus can be calibrated, which subsequently can then be utilized for specifying the control variable. After the delivery of the adjustment system and hence in regular operation of the adjustment system, merely the control variable is adapted and hence updated via the adaptation routine.

### BRIEF DESCRIPTION OF THE DRAWINGS

The attached Figures by way of example illustrate possible embodiments of the proposed solution.

FIG. 1A schematically shows a vehicle parked on a slope by representing forces to be applied by a user and on the part of the adjustment drive on opening of a side door of the vehicle.

FIG. 1B in a view corresponding with FIG. 1A shows the forces to be applied by a user and on the part of the adjustment drive on closing of the side door.

FIG. 2 in a perspective view shows an embodiment of an adjustment drive for the adjustment of a side door in the vehicle of FIGS. 1A and 1B.

FIG. 3 shows the course of a motor current for a drive motor of the adjustment drive of FIG. 2 on starting of the drive motor by emphasizing an idle current and by plotting the values for the motor current via positions of a drive element driven by the drive motor, which are detected by means of one or more Hall sensors.

FIG. 4 shows a course of the motor current via positions of the drive element driven by the drive motor, which are detected by means of one or more Hall sensors, during the execution of an embodiment of a proposed adaptation routine.

FIG. 5 shows a motor current-time-course on execution of the adaptation routine according to FIG. 4.

FIG. 6 shows the motor current-time-course of FIG. 5 by emphasizing further measurement times for the detection of a motor current in a first and a second phase of the adaptation routine.

FIG. 7 shows a schematic overview representation of the mode of operation of an embodiment of a proposed adjustment system by representing the parameters and control variables to be updated by means of an adaptation routine.

FIG. 8 shows a flow diagram for an embodiment of a proposed operating method.

### DETAILED DESCRIPTION

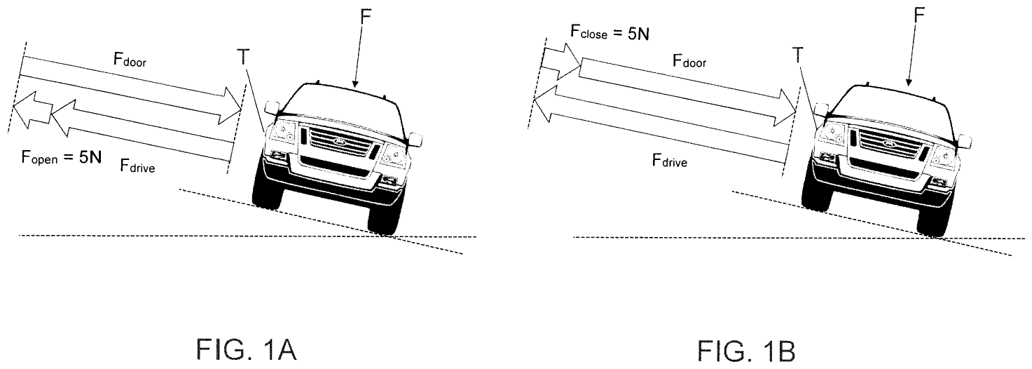

FIGS. 1A and 1B by way of example show a vehicle F parked on a slope, in which an embodiment of a proposed adjustment system is provided in order to adjust a lateral vehicle door T by power assistance. With the adjustment system a servo drive for the adjustment of the lateral vehicle door T here is provided. The objective here is that a user adjusts the vehicle door T by manual application of an adjusting force, but the adjusting force to be applied manually here does not exceed a predefined measure so that the adjustment of the vehicle door T is perceived as smooth and comfortable for a user, although the weight of the vehicle door T is comparatively large. Typically, the adjusting force to be applied in the opening direction generally and hence also with the vehicle F parked on a horizontal plane is at least slightly larger than in the closing direction. This difference again is increased considerably when the vehicle F is parked on a slope like in FIGS. 1A and 1B and the vehicle door T to be opened is to be opened in the direction of the slope.

As is illustrated in FIGS. 1A and 1B with reference to the schematic representation of the forces for a respective adjusting movement of the vehicle door T, the objective is to provide a drive force F_{drive} via at least one drive motor of the adjustment system, so that independently of the adjustment direction of the vehicle door T an adjusting force Fₒₚₑₙ or F_{close} to be applied manually always is equally large. For opening the vehicle door T, a combination of the manually applied adjusting force Fₒₚₑₙ, which should lie in the range of 5 N. and the motor-generated drive force F_{drive} then must be greater than a weight force F_{door} acting on the vehicle door T, via which the vehicle door T is loaded in the direction of a closed position. For closing the opened vehicle door T the drive force F_{drive} applied by a motor ultimately must counteract the adjusting movement of the vehicle door T in the closing direction, as otherwise the vehicle door T would be accelerated too much due to the weight force F_{door}. Here, the drive force F_{drive} applied by a motor consequently must be greater than the weight force F_{door}, namely just by the amount of the adjusting force F_{close} to be applied manually, which here again should lie in the range of 5 N.

In practice, the challenge now is to set the drive force F_{drive} to be applied in an electronically controlled way via a motor current at the at least one drive motor such that the drive force Fₒₚₑₙ or F_{close} to be applied manually is set so as to be comfortable for the user. The respective force Fₒₚₑₙ or F_{close} to be applied manually hence should be regulated electronically in such a way that the vehicle door T can comfortably be adjusted independently of the adjustment direction and feels “light”.

In principle, a corresponding control of the drive force F_{drive} to be applied by a motor is easily manageable and easily possible especially due to the corresponding design and possibly calibration of the adjustment system in a delivery state of the vehicle F. Throughout the service life, however, characteristic variables of the adjustment system and in particular of the motor drive possibly can change significantly, so that originally set and possibly even calibrated characteristic variables, which determine the motor current for the drive motor and hence the generated drive force, no longer are applicable. Hence, in the worst case undesired adjusting movements of the vehicle door T, impaired movement sequences during the adjustment of the vehicle door T and/or even malfunctions and abortions during the adjustment of the vehicle door T can occur. For example, changes that significantly have occurred due to wear at relevant characteristic variables possibly can lead to the fact that during an adjustment of the vehicle door T clamping cases no longer are reliably detected electronically.

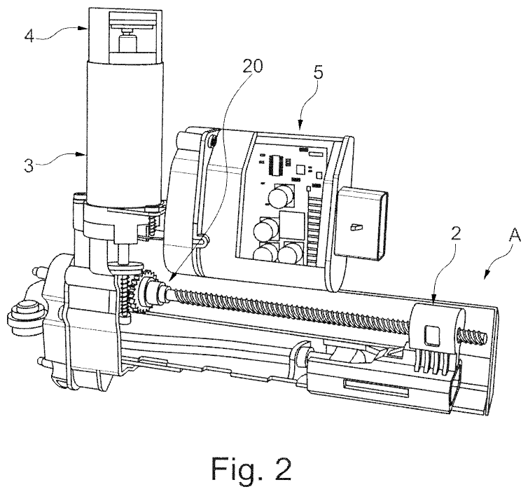

Hence, there is a need for a possibility to detect possible changes in relevant characteristic variables also throughout the service life of the adjustment system and in response thereto take any measures so that the electronically controlled generation of a drive force applied by a motor still is effected reliably and the adjusting movement of the vehicle door T still can be monitored reliably. This is remedied by the proposed solution, for which possible embodiments are explained with reference to the further FIGS. 2 to 8.

FIG. 2 here initially shows an embodiment of a mechatronic adjustment drive A, as it can be employed for the adjustment of the vehicle door T at the vehicle F of FIGS. 1A and 1B. The drive A includes an electric drive motor 3 with an integrated motor brake 4 (for example in the form of a hysteresis brake). The drive motor 3 is coupled with the spindle drive 2 via a transmission 20, in order to transmit a motor-generated drive force and a resulting drive torque to the vehicle door T. The current position of the vehicle door T can be inferred via one or more Hall sensors, which on rotation of a drive element driven by the drive motor 3 generate discrete sensor signals. A corresponding drive element for example can be a motor shaft of the drive motor 3. The control of the drive motor 3 and in particular also an evaluation of generated sensor signals of a Hall sensor (or signals of an alternatively configured position sensor) are performed by an electronic control unit in the form of a controller 5.

The controller 5 integrates a processor-supported, in particular microcontroller-based evaluation and control logic in order to control the adjustment of the vehicle door T. and in particular by specifying the motor current for the drive motor 3 control the drive force F_{drive} in a height appropriate for the respective operating situation. The evaluation and control logic implemented via the controller 5 is based on the fact that the drive force F_{drive} to be transmitted to the vehicle door T via the drive motor 3 not only depends on the motor current to the drive motor 3 alone, but also in particular on an idle current I₀ of the drive motor, a torque constant kT, a (total) gear ratio i of the transmission 20 and the spindle drive 2, and an efficiency parameter eff of the adjustment drive A characterizing the efficiency. Thus, it applies:

$${F}_{drive} = ( {I}_{motor} - {I}_{0} ) \cdot kT \cdot i \cdot eff \qquad ( Equation 1 )$$

Experience here shows that the efficiency eff of the adjustment drive A is different, depending on whether a driving or braking drive force F_{drive} must be provided via the adjustment drive A, i.e. for example in dependence on whether the vehicle door T is opened or closed corresponding to FIGS. 1A and 1B. Thus, for providing the drive force a distinction can be made between a driving or supporting drive force Fₛᵤₚₚₒᵣₜ and a braking drive force F_{brake}. For the same, another efficiency effₛᵤₚₚₒᵣₜ or eff_{brake} also is each relevant with the corresponding motor current value Iₛᵤₚₚₒᵣₜ or I_{brake}:

$${F}_{support} = ( {I}_{support} - {I}_{0} ) \cdot kT \cdot {eff}_{support} \cdot i = ( {I}_{sipport} - {I}_{0} ) \cdot {kTeff}_{support} \cdot i \qquad ( Equation 2.1 )$$

$${F}_{support} = ( {I}_{brake} - {I}_{0} ) \cdot \frac{kT}{{eff}_{brake}} \cdot i = ( {I}_{brake} - {I}_{0} ) \cdot {kTeff}_{brake} \cdot i \qquad ( Equation 2.2 )$$

The torque constant kT and the respective efficiency parameter effₛᵤₚₚₒᵣₜ or eff_{brake} here can be combined to obtain a control variable kTeffₛᵤₚₚₒᵣₜ or kTeff_{brake}, which then is relevant for specifying the height of the motor current Iₛᵤₚₚₒᵣₜ Or I_{brake} in dependence on a required height of the drive force Fₛᵤₚₚₒᵣₜ Or F_{brake}.

An embodiment of the proposed solution now refers to the fact that the control variable kTeffₛᵤₚₚₒᵣₜ and/or kTeff_{brake} is specified separately by values for the torque constant KT and the efficiency parameter effₛᵤₚₚₒᵣₜ or eff_{brake}, and the efficiency parameter effₛᵤₚₚₒᵣₜ or eff_{brake} is updated throughout the service life of the adjustment system and hence in operation of the adjustment system in connection with an adaptation routine controlled with the controller 5. Here, it was recognized that the torque constant kT of an adjustment drive A at best changes slightly throughout the service life. Here, merely a temperature dependence of the torque constant kT should possibly be observed. What is of decisive importance, on the other hand, is a separate observation of the efficiency parameter effₛᵤₚₚₒᵣₜ or eff_{brake} throughout the service life. Here again, the particular challenge consists in that in operation of the adjustment system and hence in the state of the adjustment system mounted in the vehicle F a calibration of relevant characteristic variables no longer is possible.

In the present case, not only a change of the efficiency parameter effₛᵤₚₚₒᵣₜ or eff_{brake} can be taken into account by the controller 5, but also a change of the idle current I₀ occurring throughout the service life, which likewise is included in the equations 2.1 and 2.2 as a characteristic variable.

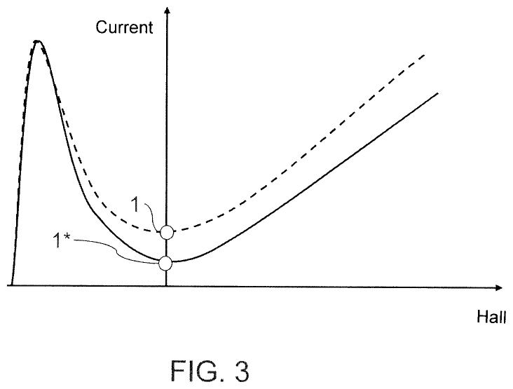

The significance of the idle current and its variability here is illustrated in detail by way of example in the diagram of FIG. 3. Here, a course of the motor current is shown via position signals of a motor shaft or a rotor of the drive motor 3 detected by means of one or more Hall sensors. From a resting, tensioned state of the adjustment system a comparatively large motor current initially is required in order to put the respective drive element into movement. The motor current then passes through a minimum, before a movement of the drive element becomes measurable with a further rise of the motor current. The respective minimum characterizes the idle current I₀, which in FIG. 3 is shown at the points 1 and 1*. A possible change of the idle current I₀ from a value at the point 1 to a value at the point 1* for example can be detected via an approximation of the idle current I₀ of the drive motor 3 during an adaptation routine or via one or more adjustment cycles and hence adjustment operations with an adjustment of the vehicle door T triggered by a user. However, a possible change of the efficiency and hence of the efficiency parameter effₛᵤₚₚₒᵣₜ or eff_{brake} cannot be inferred therefrom.

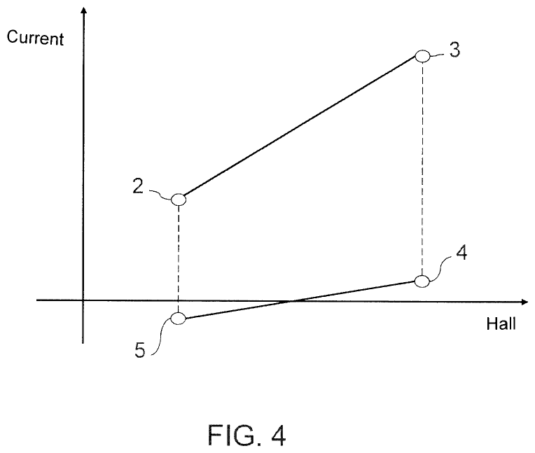

Corresponding to an embodiment of the proposed solution, which is illustrated with reference to FIG. 4, it can therefor be provided to subject the adjustment drive A to two load situations during an adaptation routine and to determine a currently valid value for the efficiency parameters effₛᵤₚₚₒᵣₜ and eff_{brake} from values for the motor current detected at specific times.

During an adaptation routine, the controller 5 initially actuates the controller 5 in a first phase to perform an adjustment against a restoring force counteracting the adjustment, which for example results from the weight force acting on the vehicle door T and from tensile forces within the system. The motor-driven drive element of the adjustment drive A here is adjusted along a first driving direction. In the diagram of FIG. 4, this corresponds to the course of the motor current from a point 2 to a point 3. At the point 3, the motor current is lowered for a subsequent second phase to such an extent that by action of the applied restoring force a return of the drive element in an opposite second driving direction is effected. This is illustrated with reference to the points 4 and 5 in the diagram of FIG. 4.

At the points 2, 3, 4 and 5 of the diagram of FIG. 4 the respective values for the motor current are detected and differences ΔIₛᵤₚₚₒᵣₜ and ΔI_{brake} are formed therefrom, which are utilized for updating the efficiency parameter effₛᵤₚₚₒᵣₜ and eff_{brake}. Here, use is made of the fact that in dependence on a currently valid coefficient of friction μ a function f(μ) can be found for the cooperating components within the adjustment drive A, in particular within the transmission 20 and the spindle drive 2, for which the following must apply from the calculated difference values ΔIₛᵤₚₚₒᵣₜ and ΔI_{brake}:

$$f ( μ ) = Δ {I}_{support} \cdot {f}_{12} ( μ ) - Δ {I}_{brake} = 0 \qquad ( Equation 3 )$$

A function f₁₂ contained therein, which is dependent on the coefficient of friction μ, in particular can contain geometrically related characteristic variables to be regarded as invariable throughout the service life of the adjustment system, so that the function f(μ) merely is dependent on the coefficient of friction μ, and for the solution of equation 3 shown above an appropriate value for the coefficient of friction μ valid in the adjustment drive A merely must be found analytically or iteratively.

On the basis of the coefficient of friction μ then determined, the efficiency parameters effₛᵤₚₚₒᵣₜ and eff_{brake} in turn can be inferred. The magnitudes of these efficiency parameters effₛᵤₚₚₒᵣₜ and eff_{brake} likewise are dependent on the coefficient of friction μ in a specific way, and thus it applies:

$${eff}_{support} = {f}_{1} ( μ ) \qquad ( Equation 4.1 )$$

$$and$$

$${eff}_{brake} = {f}_{2} ( μ ) . \qquad ( Equation 4.1 )$$

With a known value for the (current) coefficient of friction μ, a current value for the adjustment drive-specific efficiency parameter effₛᵤₚₚₒᵣₜ and eff_{brake}—relevant depending on the adjustment direction or operating situation—can thus be calculated and from the same a control variable kTeffₛᵤₚₚₒᵣₜ or kTeff_{brake} can in turn be calculated.

On the basis of the mathematical relationships considered above and in an algorithm of the controller 5 an efficiency within the adjustment drive A consequently can be inferred without any force measurements to be provided in operation of the adjustment system, and hence an updated value for efficiency parameters effₛᵤₚₚₒᵣₜ and eff_{brake} can also be used. Here, a value for an efficiency parameter effₛᵤₚₚₒᵣₜ or eff_{brake} updated in an adaptation routine can be stored as an updated and stored value or alternatively merely an updated value for the coefficient of friction μ can be stored, from which on the basis of equations 4.1 and 4.2 a required value for the efficiency parameter effₛᵤₚₚₒᵣₜ or eff_{brake} can then be determined when necessary.

A corresponding adaptation routine for example is performed by the controller 5 at defined times, for example during an adjustment of the vehicle door T, in which the vehicle door T initially is adjusted in the one and then in the other adjustment direction. Alternatively a corresponding adaptation routine can also be carried out with a closed and in particular locked vehicle door T, as for the two load situations to be considered an adjustment of the vehicle door T itself ultimately is not absolutely necessary, but merely an adjustment of the drive-side drive element coupled therewith. i.e. for example of the motor shaft or rotor of the drive motor 3.

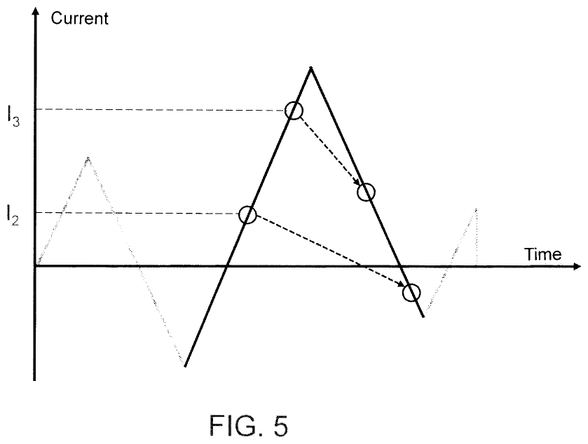

For example, the diagram of FIG. 5 also by way of example shows a course of the motor current over time for an adaptation routine carried out with a closed and locked vehicle door T. In particular measured values I₂ and I₃ are detected for the linearly rising motor current with a motor-driven adjustment of the drive element in the driving direction and for this purpose the respective positions of the drive element also are stored, for example via detected signals of one or more Hall sensors. With a backward adjustment of the drive element due to a linearly decreasing motor current, measurement values for the motor current again are detected at exactly the same positions of the drive element, for example values I₄ and I₅ (shown in FIG. 5, but not designated). From value pairs for the first phase with an adjustment of the drive element in the one driving direction and from value pairs for the second phase for a backward adjustment of the drive element in an opposite driving direction the above-mentioned values ΔIₛᵤₚₚₒᵣₜ and ΔI_{brake} then are calculated.

On traversal in the opening direction from a braced state, the drive motor 3 initially starts, goes through the system clearance and finally operates against the door and connection rigidity and against a closing bracket of a door lock. After the starting current has decayed, analogously to the representation of FIG. 3, an updated value for the idle current I₀ can be determinable when going through the system clearance. Subsequently, when going through the rising load the two (first) current values I₂ and I₃ can be detected at the two Hall positions to be stored. Thereafter, the motor current slowly is reduced until the drive element moves in the closing direction. At the Hall positions previously stored (second) current values for the motor current again are detected, from which the difference current values ΔIₛᵤₚₚₒᵣₜ and ΔI_{brake} are calculated.

In principle, the adaptation routine, which is illustrated with reference to the diagram of FIG. 2, can be triggered automatically on the part of the controller 5 in response to the presence of different adaptation criteria. Here, for example, it is not only relevant that the execution of a previous adaptation routine dates back longer than a predefined time period and/or number of adjustment cycles and hence an updating of the efficiency parameter eff or of the adjustment direction-dependent variants in the form of the efficiency parameters effₛᵤₚₚₒᵣₜ and eff_{brake} appears to be expedient. Rather, it can also play a role here that the execution of a corresponding adaptation routine is carried out as unnoticed as possible for a user of the vehicle and hence in a non-disturbing way. For example, the execution of the adaptation routine in particular can depend on that it is detected that
the vehicle door T is in a locked and closed adjustment position at the vehicle F,
in the environment of the vehicle F no valid authentication element is present, for example in the form of a key transponder (which suggests that the vehicle F is permanently parked),
no person is present in a vehicle interior of the vehicle F, and
the controller 5 and hence the entire adjustment drive A is to be put into a sleep mode in order to save electricity.

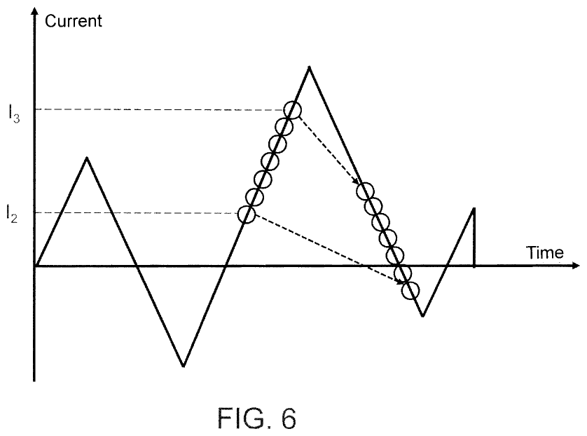

Instead of a discrete measurement of merely four current values, a possible development corresponding to FIG. 6 also for example can provide that both in the first phase and in the second phase of the adaptation routine a value for the motor current is detected for each position of the drive element detected by means of sensors. From the then existing plurality of detected motor current values a gradient can each be determined, which is included in equation 3 for ΔIₛᵤₚₚₒᵣₜ Or ΔI_{brake}.

In principle, an embodiment of the proposed solution also can provide that by means of measurement values detected in connection with the execution of the adaptation routine for an updating of the efficiency parameters effₛᵤₚₚₒᵣₜ and eff_{brake} an updating also is effected for a value of the idle current I₀, i.e. the same is not (only) determined by going through the system clearance, but is calculated. It can thus be shown that the following applies for the idle current:

$${I}_{0} = \frac{{I}_{support} \cdot {eff}_{support} - \frac{{I}_{brake}}{{eff}_{brake}}}{\frac{1}{{eff}_{brake}} - {eff}_{support}} . \qquad ( Equation 5 )$$

An updated value for the idle current I₀ thus can be stored in a memory, in particular in a memory of the controller 5, after carrying out an adaptation routine. It here can also be taken into account that the idle current I₀ is temperature dependent. Thus, different values for the idle current I₀ can be stored in the memory in dependence on different temperatures. Here, for example, especially a measured temperature at the adjustment drive A and in particular in the region of the transmission 20 then is relevant. A current or updated value for the idle current I₀ thus is also stored for example for an appropriate temperature value or temperature range. Several base or default values in the delivery state of the adjustment drive A can also be stored in a form to be overwritten. This in particular includes the possibility to store corresponding values for the idle current I₀ in a table of the form shown below:

TABLE 1

| Temp. | | | | | | | | |
|---|---|---|---|---|---|---|---|---|
| (° C.) | −30 | −20 | −10 | 0 | 20 | 40 | 60 | 80 |

| | | | | | | | |
|---|---|---|---|---|---|---|---|
| I_{0, max} | 3.2 | . . . | . . . | . . . | 2.1 | . . . | . . . |
| I₀ | 2.5 | . . . | . . . | . . . | 1.83 | . . . | . . . |
| I_{0, min} | 2.1 | . . . | . . . | . . . | 1.45 | . . . | . . . |
| I_{0, default} | 2.45 | . . . | . . . | . . . | 1.74 | . . . | . . . |

Alternatively or in addition, corresponding values for the coefficient of friction μ can be stored in a memory, in particular in tabular form corresponding to the Table shown below:

TABLE 2

| Temp. | | | | | | | | |
|---|---|---|---|---|---|---|---|---|
| (° C.) | −30 | −20 | −10 | 0 | 20 | 40 | 60 | 80 |
| μₘₐₓ | 0.150 | . . . | . . . | . . . | 0.090 | . . . | . . . | 0.110 |
| μ | 0.125 | . . . | . . . | . . . | 0.072 | . . . | . . . | 0.082 |
| μₘᵢₙ | 0.090 | . . . | . . . | . . . | 0.050 | . . . | . . . | 0.050 |
| μ_{default} | 0.120 | . . . | . . . | . . . | 0.065 | . . . | . . . | 0.071 |

For a possible updating of values of μ in such a table when carrying out an adaptation routine it can then also be verifiable whether a calculated updateable value for the coefficient of friction μ lies within predefined minimum and maximum values μₘₐₓ and μₘᵢₙ and hence is plausible. Analogously, a corresponding plausibility check with reference to minimum and maximum values I_{0,max} and I_{0,min} can also be implemented for a value to be newly stored for the idle current I₀.

A value for the control variable kTeffₛᵤₚₚₒᵣₜ or kTeff_{brake} to be utilized for one or more adjustment operations or one or more adjustment cycles can be specified in the way explained above from characteristic variables remaining up-to-date throughout the service life of the adjustment system and here in particular values for the torque constant kT and the adjustment direction-dependent efficiency parameters effₛᵤₚₚₒᵣₜ and eff_{brake}. An additional adaptation or compensation at changed temperatures in the environment of the adjustment drive A and in particular in the transmission 20 here can also easily be realized via a temperature compensation with reference to the stored values for the idle current I₀ and the coefficient of friction μ. For example, after defined times, for example every 2, 5 or 10 seconds or after detection of a temperature changed by a defined threshold value, a new determination of corresponding values for the torque constant kT can be effected on the part of the controller to below the efficiency parameter effₛᵤₚₚₒᵣₜ and/or eff_{brake}.

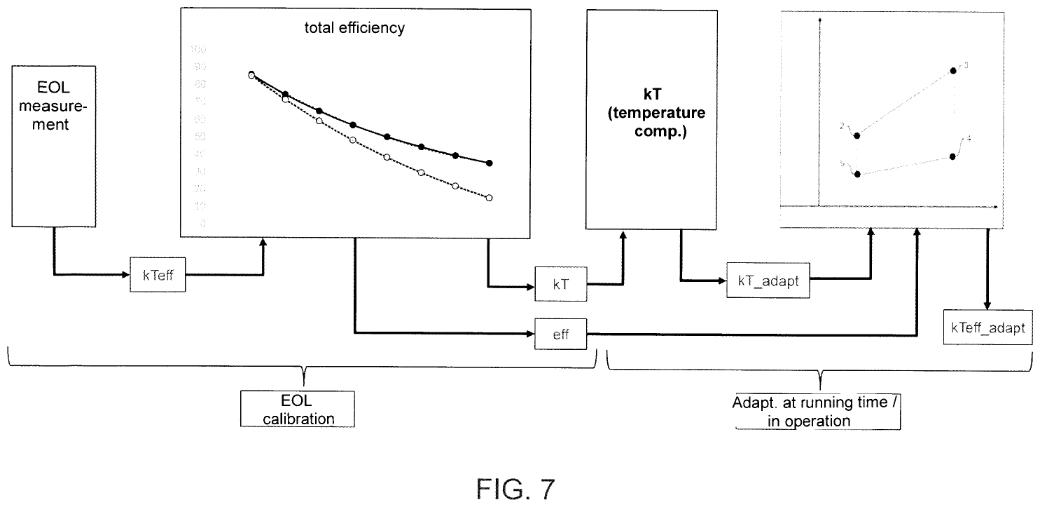

On this basis. FIG. 7 illustrates a possible fundamental procedure during the calibration of the adjustment drive A and an automated adaptation of relevant characteristic variables integrated into the adjustment drive A. It is provided, for example, that in a delivery state of the adjustment drive A and hence at the end of a manufacturing process for the adjustment drive A (so-called “end-of-line”, briefly EOL) values are measured and hence calibrated for the control variable kTeff. In connection with a corresponding EOL calibration, individual and hence specific values for the torque constant kT and the efficiency parameter eff or its adjustment direction-dependent variants effₛᵤₚₚₒᵣₜ and eff_{brake} then are present in the delivery state of the adjustment drive A for the respective adjustment drive A. Via the adaptation routine implemented on the part of the controller, repeatedly updated values for kTeff can then be utilized at the running time and hence in operation of the adjustment drive A throughout the service life, for example due to the above-described updating of values for the coefficient of friction μ and the idle current I₀ on the basis of measurement values detected during an adaptation routine (which can do without a direct force measurement). On the one hand, a temperature-compensated value for the torque constant kT thereby is provided as KT_adapt and, finally on the basis of updated values for the coefficient of friction μ and possibly the idle current I₀, an updated value kTeff_adapt for the control variable for specifying the motor current.

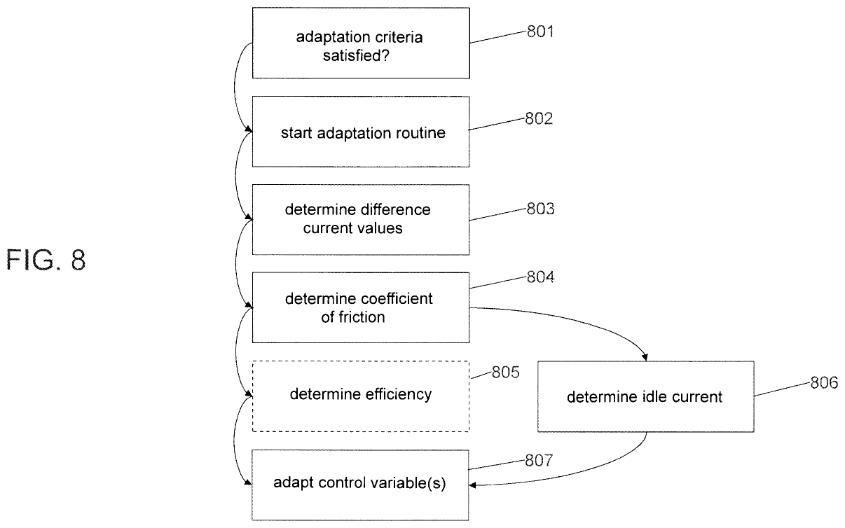

The flow diagram of FIG. 8 by way of example additionally illustrates the different steps to be carried out for an embodiment of a proposed operating method for an adjustment system corresponding to the previous explanations.

When the provided adaptation criteria are fulfilled in a first step 801, the controller 5 on the side of the adjustment drive automatically triggers the execution of an adaptation routine. The adaptation routine consequently is started in a step 802, for example with the vehicle door T completely closed and locked. In connection with the adaptation routine difference current values ΔIₛᵤₚₚₒᵣₜ and ΔI_{brake} are determined. After a corresponding step 803, a current value for the coefficient of friction μ of the adjustment drive A then is determined therefrom via an algorithm of the basis of equation 3 implemented in the controller 5 (step 804 of FIG. 8). The determination of the updated value for the coefficient of friction μ includes its storage. In an optional step 805, a current or updated value for one or more efficiency parameters effₛᵤₚₚₒᵣₜ, eff_{brake} can also be determined already from the current value of the coefficient of friction μ and be stored. In particular on the basis of the difference current values ΔIₛᵤₚₚₒᵣₜ or ΔI_{brake} determined in step 803, an updated value for the idle current I₀ can be determined in a step 806 by utilizing correspondingly calculated values for the efficiency parameters effₛᵤₚₚₒᵣₜ, eff_{brake}. At the end of the adaptation routine carried out, an updated value for the control variable(s) kTeffₛᵤₚₚₒᵣₜ and kTeff_{brake} then is determined in a step 807 from the newly calculated values.

With the embodiments explained above, a constant and foreseeable performance of the adjustment drive A can be ensured without providing any additional sensor system and it can be guaranteed throughout the service life that a control of the drive motor 3 and hence an adjusting movement of an adjustment element, for example the vehicle door T, also is reliably effected in the case of utilization-specific and wear-related changes of relevant characteristic variables and in particular neither does impair the detection of a clamping case. The proposed solution of course is not limited to the exemplary embodiments explained above, which merely are to be understood by way of example.

List of reference numerals

| | |
|---|---|
| 2 | spindle drive |
| 20 | transmission |
| 3 | drive motor |
| 4 | motor brake |
| 5 | controller (electronic control unit) |
| A | adjustment drive |
| F | vehicle |
| T | vehicle door (adjustment element) |

1. An adjustment system for a vehicle, comprising
an adjustment element adjustable along two mutually opposite adjustment directions,
an adjustment drive with at least one electric drive motor for generating a drive force for the adjustment of the adjustment element, and
an electronic control unit for controlling the drive motor by specifying a motor current for generating the drive force in a height required for an adjustment operation,
wherein via the electronic control unit at least one control variable is specified for setting the motor current,
wherein the control variable is based on a torque constant for the electric drive motor and an efficiency parameter characterizing the efficiency of the adjustment drive, and the electronic control unit is configured to carry out an adaptation routine for updating the efficiency parameter in operation of the adjustment system.

2. The adjustment system according to claim 1, wherein the electronic control unit is configured to update and store at least one value for the efficiency parameter during the adaptation routine or to update and store at least one value for an auxiliary parameter during the adaptation routine, with which the efficiency parameter can be calculated.

3. The adjustment system according to claim 1, wherein the electronic control unit is configured to calculate a value for a coefficient of friction when carrying out the adaptation routine.

4. The adjustment system according to claim 2, wherein the electronic control unit is configured to calculate a value for a coefficient of friction when carrying out the adaptation routine, wherein the electronic control unit is configured to store the calculated value for the coefficient of friction as an updated value for the auxiliary parameter.

5. An adjustment system, comprising
an adjustment element adjustable along two mutually opposite adjustment directions,
an adjustment drive with at least one electric drive motor for generating a drive force for the adjustment of the adjustment element, and
an electronic control unit for controlling the drive motor by specifying a motor current for generating the drive force in a height required for an adjustment operation,
wherein via the electronic control unit at least one control variable is specified for setting the motor current,
wherein the adjustment drive comprises a drive element coupled with the adjustment element for transmitting the drive force, which is adjustable in two mutually opposite driving directions, and the electronic control unit in an adaptation routine for updating the control variable is configured
to initially adjust the drive element in a first phase in a first driving direction via the drive motor against a restoring force and subsequently, in a second phase, permit an adjustment of the drive element in the opposite second driving direction by lowering the motor current by action of the restoring force, and
from at least two values for the motor current detected during the first phase and at least two values for the motor current detected during the second phase to form two difference values for updating the control variable.

6. The adjustment system according to claim 1,
wherein the adjustment drive comprises a drive element coupled with the adjustment element for transmitting the drive force, which is adjustable in two mutually opposite driving directions, and the electronic control unit in an adaptation routine for updating the control variable is configured
to initially adjust the drive element in a first phase in a first driving direction via the drive motor against a restoring force and subsequently, in a second phase, permit an adjustment of the drive element in the opposite second driving direction by lowering the motor current by action of the restoring force, and
from at least two values for the motor current detected during the first phase and at least two values for the motor current detected during the second phase to form two difference values for updating the control variable,
wherein the electronic control unit is configured to update a value for the efficiency parameter or a value for an auxiliary parameter, with which the efficiency parameter can be calculated, by utilizing the at least two difference values.

7. The adjustment system according to claim 5, wherein the electronic control unit is configured to detect the values for the motor current in the second phase for identical positions of the drive element, at which the values for the motor current were detected in the first phase.

8. The adjustment system according to claim 3,
wherein the adjustment drive comprises a drive element coupled with the adjustment element for transmitting the drive force, which is adjustable in two mutually opposite driving directions, and the electronic control unit in an adaptation routine for updating the control variable is configured
to initially adjust the drive element in a first phase in a first driving direction via the drive motor against a restoring force and subsequently, in a second phase, permit an adjustment of the drive element in the opposite second driving direction by lowering the motor current by action of the restoring force, and
from at least two values for the motor current detected during the first phase and at least two values for the motor current detected during the second phase to form two difference values for updating the control variable,
wherein the electronic control unit implements a search algorithm with which for a function dependent on the coefficient of friction and comprising the two difference values for the motor current a value for the coefficient of friction can be calculated, which is associated to a zero of the function, and the electronic control unit is configured to utilize the value for the coefficient of friction, which is associated to the zero, for specifying the updated efficiency parameter.

9. The adjustment system according to claim 1, wherein the electronic control unit furthermore is configured to determine and store an updated value for an idle current of the drive motor by means of the adaptation routine.

10. The adjustment system according to claim 9, wherein at least one of
the electronic control unit is configured to use the updated value for the idle current for specifying the motor current during an adjustment operation, and
the electronic control unit is configured to calculate the updated value for the idle current on the basis of the updated value for the efficiency parameter.

11. (canceled)

12. The adjustment system according to claim 1, wherein for the different adjustment directions of the adjustment element at least two different efficiency parameters are provided in the electronic control unit, so that the at least one control variable can be specified differently in dependence on the adjustment direction of the adjustment element.

13. The adjustment system according to claim 1, wherein the electronic control unit is configured to carry out the adaptation routine with an immovably fixed adjustment element or by adjusting the adjustment element.

14. The adjustment system according to claim 1, wherein the electronic control unit is configured to vary a value for the used torque constant in dependence on a measured temperature value for an adjustment of the adjustment element outside of the adaptation routine.

15. The adjustment system according to claim 1, wherein the electronic control unit is configured to vary a value for an idle current in dependence on a measured temperature value for an adjustment of the adjustment element outside of the adaptation routine.

16. The adjustment system according to claim 1, wherein the electronic control unit is configured to determine a value for the efficiency parameter on the basis of at least one value for an auxiliary parameter, which varies in dependence on a measured temperature value, for an adjustment of the adjustment element outside of the adaptation routine.

17. The adjustment system according to claim 1, wherein the electronic control unit is configured to only carry out the adaptation routine when the presence of at least two of the following adaptation criteria is electronically detected:
the adjustment element is in a locked adjustment position at the vehicle,
the execution of a previous adaptation routine dates back longer than at least one of a predefined time period and number of adjustment cycles,
in the environment of the vehicle no valid authentication element of a user of the vehicle is present, by means of which unlocking of the vehicle can be triggered,
in a vehicle interior of the vehicle no person is present,
a signal for putting the electronic control unit into a sleep mode has been generated.

18. The adjustment system according to claim 1, wherein the adjustment element is a door of a vehicle.

19. The adjustment system according to claim 1, wherein the height of the motor current for an adjustment operation depends on an adjusting force manually acting on the adjustment element and the motor current to be specified can be determined via the electronic control unit in dependence on the required height of the drive force.

20. A method for operating an adjustment system for a vehicle, which comprises
an adjustment element adjustable along two mutually opposite adjustment directions, and
an adjustment drive with at least one electric drive motor for generating a drive force for the adjustment of the adjustment element,
wherein for controlling the drive motor a motor current is specified for generating the drive force in a height required for an adjustment operation, and
wherein at least one control variable is specified for setting the motor current,
wherein at least one of
a) the control variable is based on a torque constant for the electric drive motor and an efficiency parameter characterizing the efficiency of the adjustment drive, and in operation of the adjustment system an adaptation routine is carried out for updating the efficiency parameter
and
b) the adjustment drive comprises a drive element coupled with the adjustment element for transmitting the drive force, which is adjustable in two mutually opposite driving directions, and in an adaptation routine for updating the control variable
the drive element initially is adjusted in a first phase in a first driving direction via the drive motor against a restoring force and subsequently, in a second phase, an adjustment of the drive element in the opposite second driving direction is permitted by lowering the motor current by action of the restoring force, and
from at least two values for the motor current detected during the first phase and at least two values for the motor current detected during the second phase two difference values are formed for updating the control variable.

21. (canceled)

22. The method according to claim 20, wherein a value for the torque constant is determined in a calibration routine before a first operation of the adjustment system and by utilizing a force measurement on the adjustment element adjusted by means of the adjustment drive.
